(19) United States
(12) Patent Application Publication
(10) Pub. No.: US 2007/0157093 A1
(43) Pub. Date: Jul. 5, 2007

(54) Systems and methods for adaptive help mechanisms for a user

(76) Inventor: Patrick Karcher, Gaggenau (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/320,691

(22) Filed: Dec. 30, 2005

(51) Int. Cl. G06F 17/00

(52) U.S. Cl. 715/707

(57) ABSTRACT

Systems and methods are provided for offering a user of an application one or more help pages associated with a function of the application. In one exemplary embodiment, the method may comprise analyzing the user while the user is interacting with the application, determining when the user needs help completing the function based on the analysis, selecting a level of help from a user help table based on the determining, and showing the user one or more help pages associated with the level of help.

### DESCRIPTION

I. Technical Field

The present invention generally relates to the field of data processing and to computerized systems and methods for proving help mechanisms. More particularly, the invention relates to computerized systems and methods for providing adaptive help mechanisms to users of an application while the user is interacting with the application.

II. Background

When working with various software applications, users may at times incorrectly perform a function related to that application. A user may perform the same function incorrectly a few times and may not know where to look to learn about how to correctly perform the function. For example, a user may wish to create a spreadsheet and format a column to increase the width and may incorrectly reduce the column width instead of increasing it. The user may also realize he does not know how to perform a desired function related to an application. For example, if a user wants to format a specific cell in a spreadsheet to reflect percentage as opposed to a regular numeric value, the user may not know how to perform this function.

Previous methods of assisting users of software applications include coupling the application with a user manual. The user manual may list all the functionality associated with the application and give step-by-step instructions on how to perform each function associated with the application. This method, however, is very inefficient for a user. The user may not have the user manual handy or may have misplaced it. Therefore, if the user performs a function incorrectly or he wants to learn how to perform a particular function, he has to go look for the user manual.

Many applications now include “help pages” associated with the functionality of the application. A user may access the help page through a separate menu. Once the help pages are displayed, the help pages often include an index where a user may enter specific words to display the specific help page related to the user's question. This solution, however, also may not help a user to the degree to which they need help. A user that is performing a certain function, for example, in the area of supplier relationship management the function of ordering material for an office, may complete half of the function but realize he needs help with the remaining portion. A user may try to access the help pages but may be unsure of the search terms for this function. The user may enter various search terms in order to pull up the appropriate help page from the help menu, but may not be searching for the correct term. The user may therefore never pull up the appropriate help page and may never know how to finish the function.

Accordingly, there is a need for improved systems and methods for automatically providing an adaptive help mechanism to a user of an application or system.

### SUMMARY

Methods, systems, and articles of manufacture consistent with the present invention may provide adaptive help mechanism to a user of an application or system. More particularly, methods, systems, and articles of manufacture consistent with the invention analyze actions of a user of an application and provides help mechanism to the user based on the user's knowledge level, function history, time spent on the function, and the number of errors the user makes performing the function.

As used herein, the term “function” is used to represent various tasks and transactions associated with an application or system. A function may represent a task or transaction any user of the application may perform.

One exemplary embodiment consistent with the invention relates to a method for offering a user of an application one or more help pages associated with a function of the application. The method may comprise analyzing the user's actions while the user is interacting with the application, determining when the user needs help in completing the function based on the analysis, selecting a level of help from a user help table based on the determining, and showing the user one or more help pages associated with the level of help.

Another exemplary embodiment consistent with the invention relates to a system for offering a user of an application one or more help pages associated with a function of the application. The system may comprise a processor, and a memory, wherein the processor and the memory are configured to perform a method comprising analyzing the user while the user is interacting with the application, determining when the user needs help completing the function based on the analysis, selecting a level of help from a user help table based on the determining, and showing the user one or more help pages associated with the level of help.

Another exemplary embodiment consistent with the invention relates to a computer-readable medium which stores a set of instructions which when executed performs a method for offering a user of an application one or more help pages associated with a function of the application. The method may comprise analyzing the user while the user is interacting with the application, determining when the user needs help completing the function based on the analysis, selecting a level of help from a user help table based on the determining, and showing the user one or more help pages associated with the level of help.

Additional aspects of the invention are set forth in the detailed description that follows or may be learned by practice of methods, systems, and articles of manufacture consistent with the present invention. It is understood that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate several aspects of the invention and, together with the description, serve to explain the principles of the invention. In the drawings:

FIG. 1 illustrates an exemplary system, consistent with the present invention;

FIG. 2 is a flowchart of an exemplary method for providing an adaptive help mechanism to a user, consistent with the present invention;

FIG. 3 is a flowchart of an exemplary method for analyzing a user to determine the level of help the user needs, consistent with the present invention; and

FIG. 4 is an exemplary table specifying the level of help to provide various users, consistent with the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

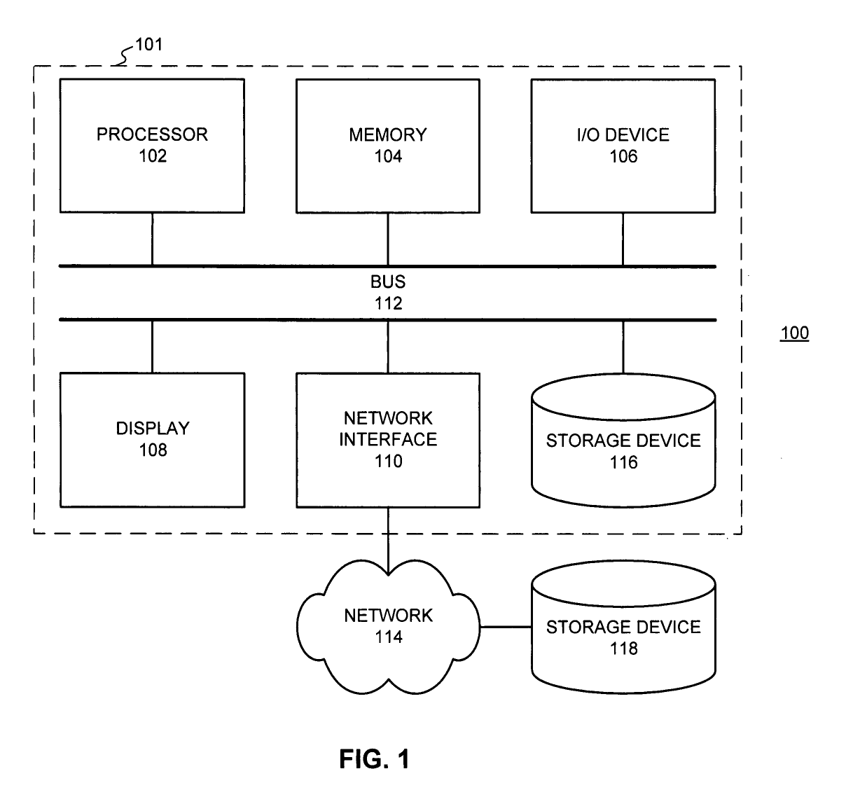

In one exemplary embodiment consistent with the present invention, an adaptive help mechanism may be used in any system, such as the exemplary system 100 illustrated in FIG. 1. System 100 may be a Supply Network Planning (“SNP”) system and may include a computer 101 having a processor 102, a memory 104, an input/output (I/O) device 106, a display 108, a network interface 110, a bus 112, a network 114, and one or more persistent storage devices 116 and 118. Processor 102, memory 104, I/O device 106, display 108, network interface 110, and storage device 116 may be configured to communicate over bus 112. Storage device 116 and network interface 110 may be configured to communicate over network 114. In one exemplary embodiment, system 100 or components thereof may be incorporated into a planning system, such as the Advanced Planning Optimizer (APO) available from SAP AG (Walldorf, Germany).

In the example of FIG. 1, computer 101 may include a mainframe, a laptop, a personal computer, a workstation, a computer chip, a digital signal processor board, an analog computer, a plurality of processors, or any other information processing device or combination of devices. Further, computer 101 may be implemented by a general purpose computer or data processor selectively activated or reconfigured by a stored computer program, or may be a specially constructed computing platform for carrying out the features and operations disclosed herein. Memory 104 may include random access memory (RAM), read-only memory (ROM), flash memory, or any other information storage device. I/O device 106 may include a keyboard, a mouse, a trackball, a light pen, an electronic tablet, or any other mechanism to communicate input or output data with SNP system 100. Display 108 may include a cathode-ray-tube monitor, a plasma screen, a liquid-crystal-display screen, or any other device to display or otherwise convey information from SNP system 100.

Network interface 110 may include an Ethernet card, an FDDI card, a modem, or any other mechanism for interfacing to a network. Bus 112 may include a data cable, a circuit board connection, a fiber optic line, a network, a serial connection, a parallel connection, or any other mechanism for conveying information between processor 102, memory 104, I/O device 106, display 108, network interface 110, and/or storage device 116. Network 114 may include a local area network (LAN), a wide area network (WAN), an Intranet, an Extranet, the Internet, a telephone network, a wireless network, a wired network, and/or any other means for communicating between locations.

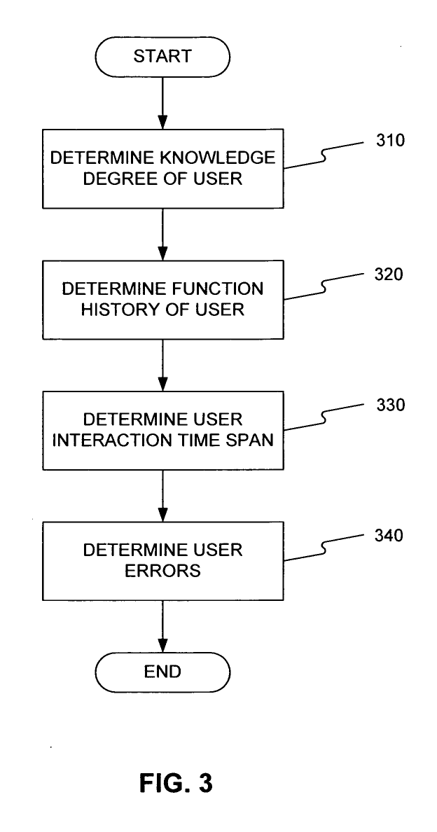

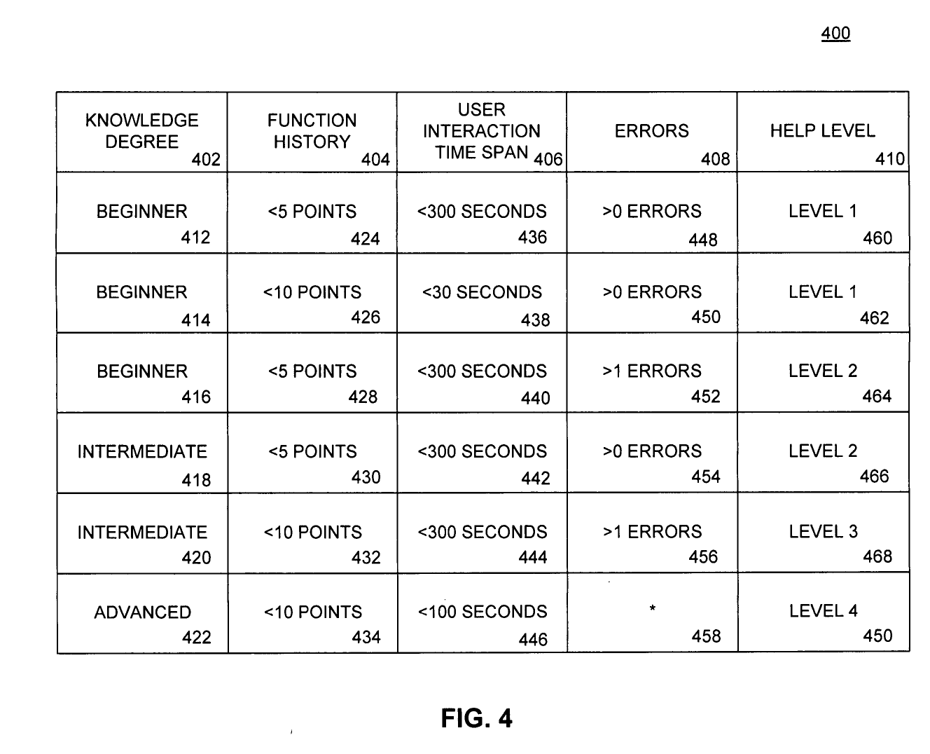

Storage devices 116 and 118 may include a hard drive, a tape drive, a RAID disk array, a database system, an optical disk drive, and/or any other device or system that persistently stores information. A database in storage devices 116 and 118 may store the data in a user help table 400 as described further with respect to FIG. 4. Other databases in storage devices 116 and 118 may store the knowledge level of the user with respect to each function within each application associated with system 100, the function history points of each user, the user's interaction time span with each function, and the user errors associated with each function, as described further with respect to FIG. 3. The above-noted items are merely examples, and, as will be appreciated by those skilled in the art, other types of data may be stored in the databases according to the needs of the user and/or the system incorporating the adaptive help mechanism.

In one exemplary embodiment consistent with the present invention, memory 104 may store one or more software applications or modules that provide help menus to users in various software application systems. Memory 104 may also include a knowledge degree process that may have program instructions that, when executed, determine the knowledge degree of a user of system 100 with respect to the software application(s) or the function(s) within the software application(s) of system 100; function history process that may have program instructions that, when executed, determines the number of times a user has worked on a particular function of system 100 and keeps track of the function history points; user interaction time span process that may have instructions that, when executed, determines the time a user spends working on a particular function associated with system 100, and error process that may have instructions that, when executed, determines the number of errors encountered while trying to complete each function associated with system 100.

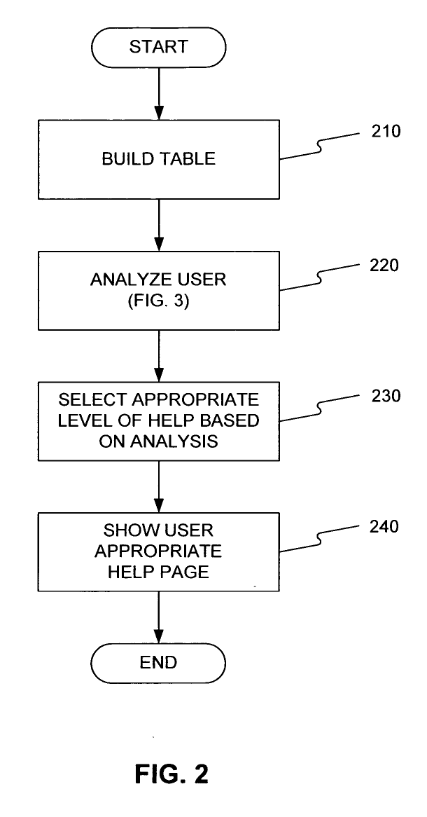

FIG. 2 is a flowchart of an adaptive help mechanism process, consistent with an embodiment of the present invention. The example of FIG. 2 is described with reference to the exemplary embodiment of system 100 as depicted in FIG. 1. However, other system environments may also be used to implement the exemplary method of FIG. 2. In determining what level of help to provide to users of system 100, an administrator of system 100 may first build a table specifying the level of help to provide to various users of different levels (stage 210).

FIG. 4 is an exemplary table specifying various help levels for system 100. As appreciated by one skilled in the art, table 400 (cf. FIG. 4) is only an example, and other configurations of this table are possible. A lookup may be done in table 400 based on various factors to determine the level of help to provide to a user. An administrator of system 100 may build a table for each function within a software applications associated with system 100.

Building a table may consist of, but is not limited to, specifying the knowledge degree of a user (402), the function history (404), the user interaction time span (406), the number of errors (408), and the level of help to provide to the user (410). The administrator may specify, as a knowledge degree (402), either “Beginner,” (412) “Intermediate,” (418) and “Advanced” (422). As appreciated by one skilled in the art, however, the administrator is not limited to only these options and other levels may be used as well. For example, an administrator may specify various levels of a user, for example “Beginner 1,” “Beginner 2,” “Intermediate 1,” and so on.

The administrator may then specify the number of function history points (404) for each knowledge degree (402). For example, the administrator may specify as the function history points in table 400 “<5 points” (424) for “Beginner” (412), and “<10 points or >5 points” (426) for “Beginner” (414).

The administrator may then specify the user interaction time span (406) for each knowledge degree (402) specified. The interaction time span may be specified in terms of seconds, minutes or hours. For example, the administrator may set “<300 seconds” for “Beginner” (412) ands “<100 seconds” for “Advanced” (422).

The administrator that builds table 400 may then specify the “Errors” 408 for each knowledge degree 402. For example, in table 400, “Beginner” 416 is associated with “>1 Error” 452. Finally the user may specify the “Help Level” 410.

In one embodiment, “wildcards” may also be used in the table. As used herein, the term “wildcard” means a special character such as an asterisk (*) or a question mark (?) that can be used to represent one or more characters. Any character or set of characters can replace a pattern matching character. Therefore the administrator may insert a wildcard character so that any value is acceptable. For example, for “Errors,” the user may enter a wildcard character “*” 458 One skilled in the art will appreciate that any wildcard character may be used, and the present invention is not limited to using an asterisk.

In one embodiment, each time a user of system 100 performs any function associated with system 100, a lookup may be performed in table 400 to determine, first, if the user's actions equate to needing help with a function and, if they do, the level of help to provide the user. The trigger of when .the lookup is performed in table 400 is based on one or more factors, as will be discussed further below.

Each function in an application may have one or more levels of help pages associated with it. Therefore, when system 100 determines to offer the user help pages associated with a particular function, the help pages are related to the function. The help pages may be very detailed for the “Level 1” 460, 462 help pages, and less detailed for the “Level 4” 450 help pages. One skilled in the art will appreciate that a higher level number may also represent more detail help pages and a lower level number may represent less detailed help pages for the more advanced user, and the present invention is not limited to the examples listed.

Once the user help table 400 is built, system 100 may monitor and analyze each user of system 100 (stage 220, FIG. 2). A process 300 for analyzing a user is discussed further below with respect to FIG. 3. System 100 may monitor a user in order to determine if and when the user of the application needs help with the application.

System 100 may first determine the knowledge degree of a user through the knowledge degree process stored in memory 104. Knowledge degree process may rely on various factors to determine the knowledge degree of a user (stage 310). Knowledge degree process may, for example, rely on the number of times a user has logged into a specific application. The more times the user has logged in, the higher the degree of knowledge for the user related to that application. A user may be awarded points with every login. For example, one login may be equal to “1” point. A system administrator may determine that a user with more than “0” points but less than “10” may be considered a “Beginner” user, or a user with more than “50” points is an “Advanced” user. System 100 may store all these configurations in databases in storage devices 116 and 118.

System 100 may also rely on the number of times a user has successfully completed the same function associated with the application to determine the knowledge degree of the user. For every successful completed function, system 100 may award a point and these points may be taken into consideration in determining the knowledge degree of the user along with the number of logins (described above). A system administrator may determine that a user with more than 0 points and less than “10” points is a “Beginner” user. For example, system 100 may determine that a user that has completed the same function five times correctly, therefore this user would be a “Beginner” user.

In one embodiment, system 100 may combine the points from the logins and the successful functions to determine the knowledge degree of the user. Therefore a system administrator may determine that a user with more than “0” total points and less than “15” total points is a “Beginner” user and so on. In one embodiment, it may be possible to define an alternative Business Add In (BAdl) where an administrator can program his or her own logic to define the knowledge degree of the user. System 100 may store each of these results in storage devices 116 and 118.

Referring once again to FIG. 3, after system 100 determines the knowledge degree of a user, system 100 may then determine the function history of the user (stage 320). Function history may consist of the number of times the user has started a particular function associated with the specific application or system and successfully finished the function. System 100 may award points for each successful function. For example, if a user successfully completes an order function by ordering a particular item, the user is given “1” point. In one embodiment, it may be possible to define an alternative Business Add In (BAdI) where an administrator can program his or her own logic to define the function history of the user.

In one embodiment, a particular application may be associated with one or more functions. Therefore, system 100 may award separate points for each function of the application. For example, a software application may be associated with a first function and a second function. System 100 may in this scenario, award points each time the user completes the first function and these points are separate from the points system 100 awards when the user completes the second function. One skilled in the art will appreciate that system 100 is not limited to awarding only one point for each successful function and other point awarding methods may be used.

After system 100 has determined the function history of the user, system 100 may then determine the user interaction time span for a particular function (stage 330). User interaction time span is determined by keeping track of the number of seconds, minutes, or hours a user takes to complete a particular function. For example, a user may spend 10 minutes completing a sales function. System 100 may rely on the user function time to determine the level of help from Table 400 (cf., FIG. 4) to offer the user.

In one embodiment, knowledge degree and function history points of the user are cumulative. Therefore, from the moment when a user first starts working with a software application or system, system 100 starts accumulating the knowledge degree and the function points associated with each function of the application related to system 100, such as the number of logins and the number of successful functions related to system 100. Therefore, each time a user starts a function, the user's interactions with the function add to the knowledge degree and the function history points, and as a result, the knowledge degree of the user and/or the function history points may increase. For example, if a user of a sales system works with a sales system and is considered a “Beginner” user, each time the user interacts with the system such as logins and the successfully completed functions, the knowledge degree of “Beginner” is affected and may be increased to “Intermediate” or “Advanced.” In one embodiment, the knowledge degree may not start at “Beginner” once the user has moved to the “Intermediate” level because the knowledge degree is cumulative. The same is true for the function history points. The user's function history points may not start at “0” each time the user starts a particular function.

In another embodiment, the user function time span and the number of errors associated with each function may not be cumulative. Therefore, each time the user starts a function, the user interaction time span and the number of errors start at “0.” System 100 records the time spent interacting with that function and also records the number of errors encountered while trying to complete that function. The next time the user starts the same function, both the user interaction time span and the number of errors start at “0” again.

System 100 may also determine the number of user errors associated with each function (stage 340). System 100 may make this determination by determining how many incorrect steps a user took while trying to complete a function. For example, in a sales function, a user may enter an incorrect credit card number, and that would equal “1” error. A user may also enter an incorrect city associated with a certain country, and that may also equal “1” error. Therefore, system 100 may determine that in completing a sales function, this user made 2 errors.

Each user of system 100 may be analyzed each time they log into the system for the above-listed factors. System 100 may, while the user is navigating a particular application, select an appropriate level of help from table 400 to offer the user (stage 230) at any time during the user's interaction with the particular application.

In one embodiment, system 100 may analyze the user and at the same time offer the user various help menus based on table 400 (cf., FIG. 4). Therefore, while the user is navigating an application and performing various functions, and the system is keeping track of function history points, number of errors, and time spent on the functions, system 100 may at the same time be offering the user various levels of help based on table 400.

A lookup may be done in table 400 (cf., FIG. 4) at anytime during a user's interaction time with a function in an application. In one embodiment, the interaction time span triggers when to offer the user help. After a certain amount of time passes and a user is still on the same function, then system 100 may do a lookup in table 400 to determine what level of help to send the user. System 100 may determine that after “300 seconds” of the user interacting with a particular function, a look up should be done in the user help table 400 to determine the level of help to offer the user because the user is taking too long to complete the function. System 100 may first have to determine the knowledge degree of the user, the function history, and the number of errors based on already gathered information. If, for example, system 100 determines that this particular user is an “Intermediate” user with “8 points” of function history and “3” errors, then system 100 may offer Level 3 help (cf. FIG. 4, 468).

In another embodiment, the number of user errors may determine a trigger point of when to send the user help. System 100 may determine that after “3 errors” on the same function, a lookup should be done in the user help table to offer the user help on the particular function.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed:

1. A method for offering a user of a computer application one or more help pages associated with a function of the application, comprising:
analyzing action of the user while the user is interacting with the application;
determining when the user needs help to complete the function based on the analysis;
selecting a level of help from a user help table based on the determining; and
showing the user one or more help pages associated with the level of help.

2. The method of claim 1, wherein the analyzing further comprises at least one of:
determining the knowledge degree of the user associated with the application;
determining the function history of the user associated with the function;
determining the user interaction time span associated with the function; and
determining the number of user errors associated with the function.

3. The method of claim 2, wherein determining the knowledge degree of the user further comprises:
determining the number of times the user has worked on the application; and
selecting the knowledge degree based on the worked number determination.

4. The method of claim 2, wherein determining the function history of the user further comprises:
determining the number of times the user has successfully completed the function previously; and
assigning a predetermined amount of function history points for each successfully completed function.

5. The method of claim 2, wherein determining the user interaction time span further comprises:
measuring the time it takes for the user to interact with the function.

6. The method of claim 2, wherein determining when the user needs help to complete the function further comprises:
determining whether a trigger point has been reached by the user.

7. The method of claim 6, wherein the trigger point is reached when either a maximum number of errors associated with the function has been reached or a maximum user interaction time associated with the function has been reached.

8. A system for offering a user of a computer application one or more help pages associated with a function of the application, comprising:
a processor; and
a memory,
wherein the processor and the memory are configured to perform a method comprising:
analyzing action of the user while the user is interacting with the application;
determining when the user needs help to complete the function based on the analysis;
selecting a level of help from a user help table based on the determining; and
showing the user one or more help pages associated with the level of help.

9. The system of claim 8, wherein the method further comprises at least one of:
determining the knowledge degree of the user associated with the application;
determining the function history of the user associated with the function;
determining the user interaction time span associated with the function; and
determining the number of user errors associated with the function.

10. The system of claim 9, wherein determining the knowledge degree of the user further comprises:
determining the number of times the user has worked on the application; and
selecting the knowledge degree based on the worked number determination.

11. The system of claim 9, wherein determining the function history of the user further comprises:
determining the number of times the user has successfully completed the function previously; and
assigning a predetermined amount of function history points for each successfully completed function.

12. The system of claim 9, wherein determining the user interaction time span further comprises:
measuring the time it takes for the user to interact with the function.

13. The system of claim 9, wherein determining when the user needs help to complete the function further comprises:
determining whether a trigger point has been reached by the user.

14. The system of claim 13, wherein the trigger point is reached when either a maximum number of errors associated with the function has been reached or a maximum user interaction time associated with the function has been reached.

15. A computer-readable medium which stores a set of instructions which when executed perform a method for offering a user of an application one or more help pages associated with a function of the application, the method comprising:
analyzing action of the user while the user is interacting with the application;
determining when the user needs help to complete the function based on the analysis;
selecting a level of help from a user help table based on the determining; and
showing the user one or more help pages associated with the level of help.

16. The computer-readable medium of claim 15, the method further comprising at least one of:
determining the knowledge degree of the user associated with the application;
determining the function history of the user associated with the function;
determining the user interaction time span associated with the function; and
determining the number of user errors associated with the function.

17. The computer-readable medium of claim 15, wherein determining the knowledge degree of the user further comprises:
wherein determining the knowledge degree of the user further comprises:
determining the number of times the user has worked on the application; and
selecting the knowledge degree based on the worked number determination.

18. The computer-readable medium of claim 15, wherein determining the function history of the user further comprises:
determining the number of times the user has successfully completed the function previously; and
assigning a predetermined amount of function history points for each successfully completed function.

19. The computer-readable medium of claim 15, wherein determining the user interaction time span further comprises:
measuring the time it takes for the user to interact with the function.

20. The computer-readable medium of claim 15, wherein determining when the user needs help to complete the function further comprises:
determining whether a trigger point has been reached by the user.
